(19) United States
(12) Patent Application Publication
(10) Pub. No.: US 2010/0026555 A1
(43) Pub. Date: Feb. 4, 2010

(54) OBSTACLE DETECTION ARRANGEMENTS IN AND FOR AUTONOMOUS VEHICLES

(76) Inventors: William L. WHITTAKER, Pittsburgh, PA (US); Joshua Johnston, Logan, UT (US); Jason Ziglar, Pittsburgh, PA (US)

Correspondence Address: REED SMITH LLP, P.O. BOX 488, PITTSBURGH, PA, 15230-0488, US

(21) Appl. No.: 11/761,347

(22) Filed: Jun. 11, 2007

Related U.S. Application Data
(60) Provisional application No. 60/812,693, filed on Jun. 9, 2006.

(51) Int. Cl. G01S 13/93; G06K 9/62

(52) U.S. Cl. 342/70; 382/224

(57) ABSTRACT

An arrangement for obstacle detection in autonomous vehicles wherein two significant data manipulations are employed in order to provide a more accurate read of potential obstacles and thus contribute to more efficient and effective operation of an autonomous vehicle. A first data manipulation involves distinguishing between those potential obstacles that are surrounded by significant background scatter in a radar diagram and those that are not, wherein the latter are more likely to represent binary obstacles that are to be avoided. A second data manipulation involves updating a radar image to the extent possible as an object comes into closer range. Preferably, the first aforementioned data manipulation may be performed via context filtering, while the second aforementioned data manipulation may be performed via blob-based hysteresis.

### CROSS-REFERENCE TO RELATED APPLICATION

This application claims the benefit under 35 U.S.C. §119(e) of the earlier filing date of U.S. Provisional Application Ser. No. 60/812,693 filed on Jun. 9, 2006, which is hereby incorporated by reference.

### BACKGROUND OF THE INVENTION

1. Field of the Invention

The present invention relates generally to methods, systems, and apparatus for the autonomous navigation of terrain by a robot, and in particular to arrangements and processes for discerning and detecting obstacles to be avoided.

2. Description of the Background

Herebelow, numerals presented in brackets—[ ]—refer to the list of references found towards the close of the instant disclosure.

Autonomous (or, “self-guided” or “robotic”) vehicles (e.g., cars, trucks, tanks, “Humvees”, other military vehicles) have been in development for several years, and continued refinements and improvements have lent great promise to a large number of military and non-military applications.

One perennial challenge addressed in the development of autonomous vehicles lies in the mechanics of self-guiding and navigating and, more particularly, in the avoidance of obstacles, or the detection of obstacles and prompting of corrective action (e.g., swerving). Obstacles, as such, can take on a variety of forms, some lethal and some not. Those obstacles which are to be avoided at all costs are termed “binary obstacles”. In the case of military applications, such obstacles could be in the form of a tank trap, a tank or vehicle barrier, telephone poles, large boulders, or other sizeable items that would readily compromise or inhibit a sufficiently free and smooth passage of the vehicle. In civilian applications, and especially in the context of smaller vehicles, binary obstacles would clearly include those of a scale just mentioned, but could also include smaller items such as cars, bicycles, pedestrians, animals and relatively small objects that yet could cause problems if struck or run over.

Over the years, millimeter wave radar has emerged as a technology well-matched to outdoor vehicle navigation. It sees through dust and rain, doesn't depend on lighting, senses over a useful range, and can be cheap to mass-produce. Car manufacturers have successfully used radar for adaptive cruise control (ACC) and now offer them as options on luxury models and trucks [1][2] [3]. Adaptations for autonomous vehicle navigation through unstructured terrain, however, have been much less successful for a variety of less-publicized weaknesses associated with radar [4].

Radar is particularly good at detecting binary obstacles in the road, so this approach leaves the problem of identifying road edges and rough areas to other sensors, like LIDAR. LIDAR can thus address terrain challenges rather well, but leaves some concern about detecting all binary obstacles at the ranges sufficient to ensure the vehicle's avoidance thereof.

Challenges of obstacle detection and avoidance certainly vary; a two-part problem thus arises by way of finding the rough parts of the terrain that should be avoided but may not be catastrophic, and finding binary obstacles that cannot be hit at any cost.

Terrain can be identified with an estimate of the risk or cost associated with its traversal, while obstacles that must be avoided are assigned maximum cost and termed binary obstacles, because they either exist or don't exist. Some binary obstacles are indigenous, like telephone poles, fence posts, cattle gaps, and rocks; others might be spontaneously introduced by people, like traffic barriers and other vehicles and steel hedgehog-style tank traps. The challenge for sensors is to identify these obstacles consistently at long ranges with low numbers of false positives.

Prior attempts at radar sensing have faced several major hurdles. The low angular resolution, typically 1° to 2°, prevents shape identification of small obstacles. Only minimum data is observed, such as polarization, phase shift, and intensity of backscatter returns. Methods using electromagnetic effects like polarization to discriminate between soft and hard or horizontal and vertical objects can be confused in an object-rich environment like a desert road [5][6]. This leaves the intensity of backscatter returns, binned by range (linear distance from the radar antenna to an object) and azimuth (horizontal rotational angle of the antenna, from 0 to 360 degrees) as a sole, and usually inadequate, identifier.

Several previous efforts to address this problem have used fixed thresholding [7][8] or constant false alarm rate (CFAR) thresholding [9] on the backscatter intensity data. It has been found that such methods are of marginal benefit at best on well-maintained highways and wholly insufficient for off-highway driving. The use of radar in autonomous vehicles to sense the environment has thus been generally limited to very structured environments like container storage areas at port facilities [10] or identifying clear obstacles on open, level ground [11]. For mainstream civilian use, thresholds are generally set at the size of a motorcyclist, or the smallest obstacle of concern on a highway, while hazardous desert passages present many dangers with smaller radar cross-sections that are not readily detected or addressed with conventional equipment.

There is also the challenge of adequately discerning benign obstacles that do not need to be averted. While many obstacles have surfaces that reflect energy away from the radar antenna, returning very little backscatter, objects that pose little risk to a vehicle, such as brush, gentle inclines, and small rocks can have very large radar cross-sections and then return false positives. An insignificant object like a small rock, pothole, or bush may even have greater intensity than a guardrail, telephone pole, or fence post. Thus, the intensity of backscatter returns is a poor direct measure of the risk posed by an object.

In view of the foregoing, a major need has been recognized in connection with implementing an arrangement for providing obstacle detection in autonomous vehicles that overcomes the shortcomings and disadvantages of prior efforts.

### SUMMARY OF THE INVENTION

In accordance with at least one presently preferred embodiment of the present invention, there is broadly contemplated herein an arrangement for obstacle detection in autonomous vehicles wherein two significant data manipulations are employed in order to provide a more accurate read of potential obstacles and thus contribute to more efficient and effective operation of an autonomous vehicle. A first data manipulation involves distinguishing between those potential obstacles that are surrounded by significant background scatter in a radar diagram and those that are not, wherein the latter are more likely to represent binary obstacles that are to be avoided. A second data manipulation involves updating a radar image to the extent possible as an object comes into closer range.

Preferably, the first aforementioned data manipulation may be performed via context filtering, while the second aforementioned data manipulation may be performed via blob-based hysteresis.

Generally, there is broadly contemplated in accordance with at least one presently preferred embodiment of the present invention, a method of providing obstacle detection in an autonomous vehicle, the method comprising the steps of: obtaining a radar diagram; discerning at least one prospective obstacle in the radar diagram; ascertaining background scatter about the at least one prospective obstacle; classifying the at least one prospective obstacle in relation to the ascertained background scatter; and refining the radar diagram and reevaluating the at least one prospective obstacle; the reevaluating comprising repeating the steps of ascertaining and classifying.

Further, there is broadly contemplated herein, in accordance with at least one presently preferred embodiment of the present invention, a system for providing obstacle detection in an autonomous vehicle, the system comprising: an arrangement for discerning at least one prospective obstacle in a radar diagram; an arrangement for ascertaining background scatter about the at least one prospective obstacle; an arrangement for classifying the at least one prospective obstacle in relation to the ascertained background scatter; and an arrangement for refining the radar diagram and reevaluating the at least one prospective obstacle; the refining and reevaluating arrangement acting to prompt a repeat of ascertaining background scatter about the at least one prospective obstacle and classifying the at least one prospective obstacle in relation to the ascertained background scatter.

The novel features which are considered characteristic of the present invention are set forth herebelow. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a schematic of an overall architecture of navigation software in which at least one presently preferred embodiment of the present invention may be employed;

FIG. 2 schematically illustrates a processing pathway of a radar obstacle detection method.

FIG. 3 illustrates returns from an exemplary 180 degree radar sweep to a 75 m range.

FIG. 4 shows the application of an energy filter to radar data.

FIG. 5 shows backscatter returns from a 30 gallon plastic trash can.

FIG. 6 graphically illustrates a kernel mask that may be employed during context filtering.

FIG. 7 graphically provides a side-by-side comparison of unprocessed and context-filtered radar data from a desert site.

FIG. 8 provides a side-by-side comparison of a successive images of an obstacle refined by blob-based hysteresis.

FIG. 9 graphically illustrates time indexing in a FMCW radar.

### DETAILED DESCRIPTION OF PREFERRED EMBODIMENTS OF THE PRESENT INVENTION

It is to be understood that the figures and descriptions of the present invention have been simplified to illustrate elements that are relevant for a clear understanding of the invention, while eliminating, for purposes of clarity, other elements that may be well known. The detailed description will be provided herebelow with reference to the attached drawings.

Hereby fully incorporated by reference, as if set forth in their entirety herein, are the copending and commonly assigned U.S. patent applications filed on even date herewith entitled “SOFTWARE ARCHITECTURE FOR HIGH-SPEED TRAVERSAL OF PRESCRIBED ROUTES” (inventors William Whittaker, Kevin Peterson, Chris Urmson) and “SYSTEM AND METHOD FOR AUTONOMOUSLY CONVOYING VEHICLES” (inventors Chris Urmson, William Whittaker, Kevin Peterson). These related applications disclose systems, arrangements and processes in the realm of autonomous vehicles that may be freely incorporable with one or more embodiments of the present invention and/or represent one or more contextual environments in which at least one embodiment of the present invention may be employed. These related applications may also readily be relied upon for a better understanding of basic technological concepts relating to the embodiments of the present invention.

In the following description of embodiments of the present invention, the term “autonomous” is used to indicate operation which is completely automatic or substantially automatic, that is, without significant human involvement in the operation. An autonomous vehicle will generally be unmanned, that is without a human pilot, or co-pilot. However, an autonomous vehicle may be driven or otherwise operated automatically, and have one or more human passengers. An autonomous vehicle may be adapted to operate under human control in a non-autonomous mode of operation.

As used herein, “vehicle” refers to any self-propelled conveyance. In at least one embodiment, the description of the present invention will be undertaken with respect to vehicles that are automobiles. However, the use of that exemplary vehicle and environment in the description should not be construed as limiting. Indeed, the methods, systems, and apparatuses of the present invention may be implemented in a variety of circumstances. For example, the embodiments of the present invention may be useful for farming equipment, earth moving equipment, seaborne vehicles, and other vehicles that need to autonomously generate a path to navigate an environment.

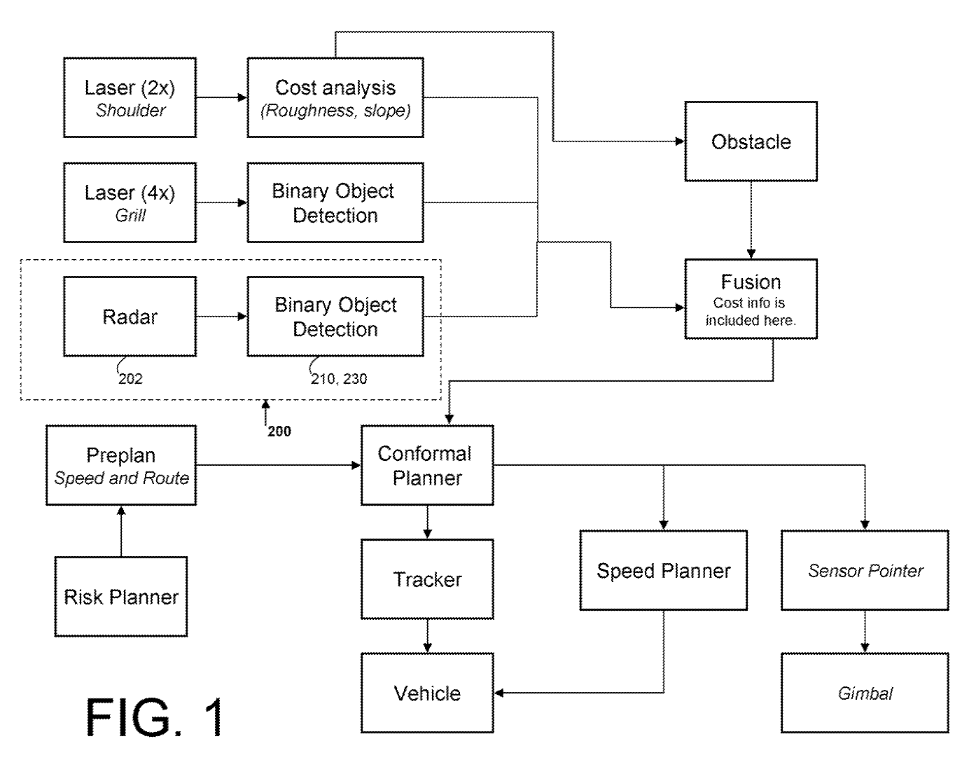

FIG. 1 shows a schematic of an overall architecture of navigation software in which at least one presently preferred embodiment of the present invention may be employed. A further appreciation of specific components forming such an architecture, as may be employed as an illustrative yet non-restrictive environment for at least one presently preferred embodiment of the present invention, may be gleaned from “SOFTWARE ARCHITECTURE FOR HIGH-SPEED TRAVERSAL OF PRESCRIBED ROUTES”, supra. As such, a radar 202 and binary detection arrangement (comprising, preferably, a pipeline 210 and radar module 230 as discussed herebelow) can preferably be integrated into a navigation architecture as shown in FIG. 1 and advantageously provide radar-based obstacle detection in such a context in a manner that can be more fully appreciated herebelow.

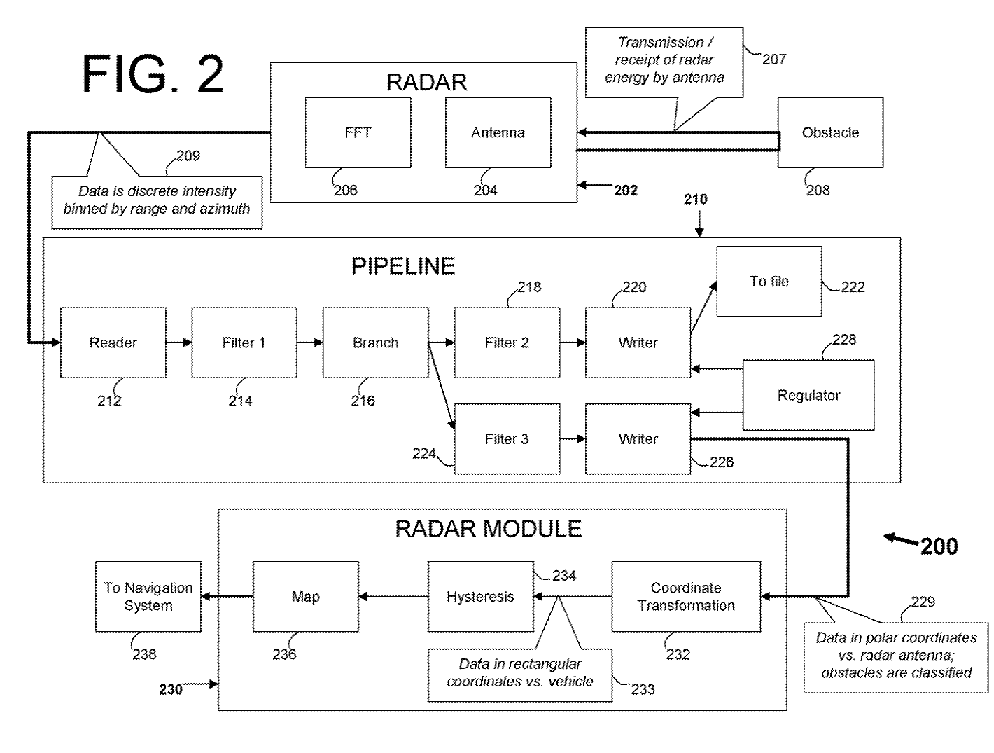

FIG. 2 broadly illustrates a processing pathway of a radar obstacle detection arrangement 200, and associated method, in accordance with a presently preferred embodiment of the present invention. Reference to FIG. 2 will continue to be made throughout the instant disclosure as needed.

Most generally, in an autonomous vehicle in accordance with at least one presently preferred embodiment of the present invention, a radar arrangement 202 transmits and receives radar energy (207) in a general sweep (to be better appreciated further below) and as such will rebound from one obstacle 208 after another. Data is then binned (209) by range and azimuth and fed to a “radar pipeline” 210, also to be better appreciated further below, that context-filters data in accordance with at least one particularly preferred embodiment of the present invention before proceeding (229) to a radar module 230. At radar module 230, data is preferably transformed from polar coordinates to rectangular coordinates (relative to the vehicle in question) before undergoing, in accordance with at least one particular preferred embodiment of the present invention, an updating and refinement (to the extent possible in view of time and range constraints) via blob-based hysteresis before being transmitted (238) to a remainder of a general navigation system (such as that discussed and illustrated herein with respect to FIG. 1.

By way of some general considerations of relevance to at least one embodiment of the present invention, it is to be noted that when working with radar the energy of a 3D wave emitted from a point source decays as 1/R². Radiation emitted by the antenna, reflected by a target, then returned to the receiver decays by a factor of 1/R⁴. This means that an object at close range will have a much greater backscatter than the same object at far range. The radar antenna can compensate for this internally by multiplying by a regression-fitted R⁴ function so it reports range-invariant intensities. An object at close range will thus have the same intensity output value as it does at far range. While this solves several problems, it also increases noise at the greater ranges.

The radar indicated at 202 can be embodied by essentially any suitable equipment; a very good illustrative and non-restrictive example would be a Navtech DSC2000 77 GHz Frequency Modulating Continuous Wave (FMCW) radar. An advantage of such equipment is that it provides the capability of applying (206) a Fast Fourier Transform (FFT) to data received by an antenna 204, whereupon the data can be binned by an onboard DSP, thus permitting the data to become available over Ethernet. In accordance with an illustrative and non-restrictive example, and as will be appreciated in discussions of working examples herein, the data output from such a radar 202 is expressed as intensity of backscatter in bins measuring 1.2 degrees in azimuth by 0.25 m in range. Such a radar provides a vertical beam width of 4 degrees with a scan rate (i.e., rotational velocity) of 360 degrees in 0.4 seconds.

Preferably, data output from radar 208 is in the form of individual packets each containing a radar vector which is an 800-member vector of discretized intensities. By way of an illustrative and non-restrictive example (and as observed with an antenna from the Navtech radar mentioned above), values can range from 0 (minimum intensity) to 144 (maximum intensity) and be indexed by range in 0.25 m increments from 0 to 200 meters. Each radar vector also preferably is recorded with an azimuth at 0.1 degree precision. A full 360 degree sweep can thus include about 310 radar vectors at 1.2 degree separation. Because, as is normally the case, antenna 204 is spun at an imprecisely controlled rate and the samples are timed at 1 ms separation, the exact number of radar vectors in a sweep is not necessarily guaranteed. Additionally, the azimuth direction of radar vectors can of course vary slightly between sweeps, so the unique azimuth of any given radar vector should preferably be recorded.

Inasmuch as objects behind the vehicle need not be considered in most practical applications, the half of the radar field of view facing “backward” can readily be eliminated, only those objects in the 180 degree arc from “straight left” to “straight right” in front of the sensor need be analyzed. The antenna 204 can thus be scanned at a steady rate, with about 0.2 seconds between when the left side data and right side data are recorded during a single sweep. Preferably, radar vectors will be individually time-stamped with their arrival times to ensure that proper vehicle poses are retrievable. Inasmuch as a noticeable increase in FFT noise at 75 meters has been observed, which at any rate represents a still considerable range within which to adequately navigate and detect and avoid obstacles at speeds of up to about 20 meters per second, it is certainly conceivable to consider ranges solely of less than 75 meters, whereby radar returns will more or less be noise-free.

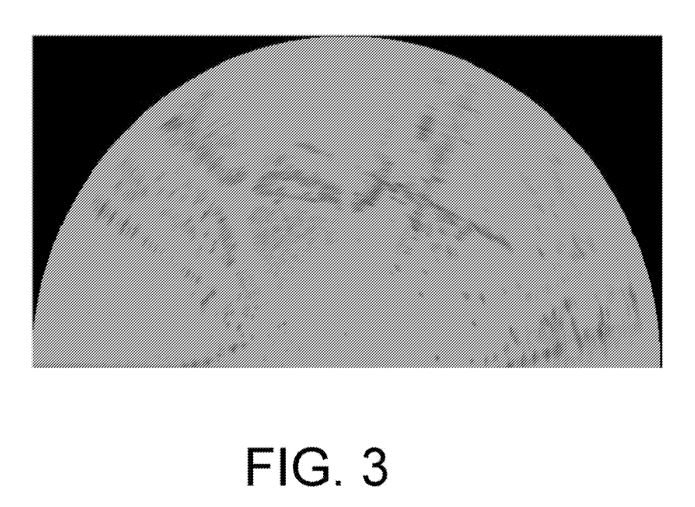

After retrieval from the radar antenna 204, radar vectors are preferably collected into a radar image, which is a wrapper for a matrix that indexes intensity by azimuth and range. This radar image can be expressed as a 180 degree view of radar backscatter intensities, an example of which is shown in FIG. 3. More particularly, shown in FIG. 3 is an exemplary 180 degree radar sweep to a 75 m range with the Navtech equipment discussed above. Green represents areas of low backscatter, while red areas darken in proportion to the strength of backscatter returns. As will be appreciated herebelow, supported radar image functions include the ability to form windowed iterators and writing to image file or over Ethernet.

Referring again to FIG. 2, the aforementioned radar images preferably pass through a software pipeline 210 that performs context-filtering operations on the data, the result of which will be more fully appreciated herebelow. As such, the pipeline 210 can preferably contain several software classes, including a reader 212, first filter 214, branch 216, followed in parallel by (a) a second filter 218 and a writer 220 to file (222) and (b) a third filter 224 and a writer 226 to Ethernet. A regulator 228 governing writers 220/226 is also preferably included. Overall, pipeline 210 is preferably configured at runtime with a custom scripting language.

Reader 212 will preferably receive radar vectors from the radar 202 over Ethernet and form the radar images. Writers preferably transmit data to file, shared memory, or over Ethernet; here, writers 220/226 are shown as writing to file and transmitting to Ethernet, respectively. In between reader 212 and writers 220/226 are configurable filters 214/218/224 as shown that can be ordered via the scripting language. All of these classes derive from the Pipe class, which contains a pointer to the previous Pipe in the Pipeline 210 (FIG. 2). Branching is also supported (216), allowing multiple filtering methods on the same data or multiple output formats. Of all the class types—Reader, Filter, Writer, Branch, Regulator—only the reader 212 need be radar hardware specific. Thus, if there is a need to support a different radar antenna (e.g., a different azimuth-sweeping radar antenna), only the reader 212 would need to be modified. First filter 214 will preferably undertake the “context filtering” as broadly understood herein (and as described in more detail herebelow in accordance with at least one preferred embodiment) while second filter 218 and/or third filter 224 can undertake secondary filtering operations such as additional thresholding (e.g., to further increase the likelihood of avoiding false positives).

To ensure that processing occurs in real time without overwhelming pipeline 210 with a “logjam” of several radar sweeps at the same time, regulator 229 can preferably apply a scheme to avoid or obviate such a contingency. In such a scheme, for instance, a single radar can be passed “backward” (i.e., towards reader 212) from any “final” element of the pipeline 210 (e.g., either of the writers 220/226). Here, the filters 214/218/224 would not act on the data represented by the image. When that radar image reaches the beginning of the series, the reader 212 can fill it with radar vectors and send it back “forward” through the pipeline 210 (i.e., towards writers 220/226), whereupon the filters 214/218/224 would actually act on the data.

A pipeline 210 in accordance with at least one embodiment of the present invention will preferably afford some flexibility such that, e.g., filters can be dropped in and out or be reconfigured at runtime. The radar antenna 202 can also be replaced with required changes isolated to only one sub-class (i.e., reader class). Finally, the implementation of the radar image wrapper class can be completely reworked without affecting the filter processes. The radar image can be defined as a matrix of Cartesian coordinates, a lookup table of Cartesian coordinates for a polar coordinate storage structure, and directly as a polar coordinate structure. The pipe classes need not be changed to support such modifications.

The radar method up to this point is modular, self-contained, and can operate freestanding. Its output (shown here on the output from writer 226) includes the location of obstacles indexed by azimuth and range and marked with data collection time stamps. To transform these values into a real world location of an obstacle, however, requires knowledge of the position antenna 204 at the time of each data collection. On most robots, this information is available to the sensor from the vehicle's estimation of position, orientation in 6 DOF (Degrees of Freedom). To utilize these resources without losing the modularity of the Pipeline approach, an additional radar module (230) process is preferably added that functionally follows pipeline 210.

The radar module 230 preferably references the vehicle pose history, and therefore is not stand-alone. It receives input from the end of the pipeline 210 over Ethernet. This input data includes the azimuth and range (relative to the sensor at a collection timestamp) of location bins containing obstacles. These obstacles preferably are reported with binary confidence and are not further classified. Rather, radar module 230 is preferably configured to convert (232) the data from polar coordinates (azimuth range) relative to the sensor to a latitude/longitude location on the Earth's surface. The output 233 of conversion 232 thus preferably takes the form of a rectangular map, e.g., 100 meters by 100 meters, centered on the vehicle at an arbitrary time.

As such, each obstacle pixel preferably ends up being converted to Cartesian coordinates, then transformed (236) by a calibration file and the vehicle pose to determine its location in the map. If an object has not already been reported at that location, it is added, and the map is forwarded (238) to the robot's navigation and planning algorithms (see FIG. 1). Prior to the mapping step (236), an updating of data via blob-based hysteresis (234) preferably takes place, to be better understood herebelow.

The disclosure now continues with a more detailed discussion of context filtering and blob-based hysteresis, and the advantages of both as compared with other conceivable implementations. Reference should continue to be made to FIG. 2, in addition to other Figures mentioned herebelow.

Generally speaking, a significant advantage enjoyed in accordance with at least one embodiment of the present invention is the rendering of a priori assumptions that are intuitive after posing radar data in image format. Existing filtering and classification methods can essentially be borrowed from camera-based image processing to identify obstacles representing a significant risk to a vehicle while not reporting false positives that are actually traversable. However, radar still reports little except range to objects, providing very few discriminable features.

With 2D intensity information alone, there is little that is inherently different between the backscatter returns from a rut and those from a telephone pole. The former presents no problem to a large vehicle while driving into the latter would be disastrous. In short, while there is very little noise in a radar image, the signal to clutter ratio is extremely low in unstructured environments. Clutter produces high backscatter returns but is not dangerous to a HMMWV. An important challenge is thus to remove clutter and avoid false positives.

In analogous sensing modalities, additional information is gleaned to eliminate clutter. LIDAR produces detailed geometry from which shape and roughness can be extracted. Stereovision and visual segmentation allow separation of objects that stick up sharply from the smooth road. Available radar antennas have too low a resolution for shape identification and have too great a vertical beam width to produce height maps.

Radar images from a 77 GHz antenna have several important characteristics. Because the data is collected in polar format, the lateral resolution is higher close to the antenna than farther away. Roads, smooth building walls, and other planar surfaces reflect very little energy toward the radar unless their normal vector points back at the antenna. Internal angles, like the corner between two walls and a ceiling reflect strongly. Rough surfaces like grass, brush, brick walls, and plastics are less directionally dependent and produce moderate backscatter returns, which can create false positives.

There are as many exceptions as rules, however. A street gutter is a non-oblique angle in only two directions, so it may return very little energy, while a drain in the gutter could become visible. A road may have few returns until it goes uphill and faces the antenna a little more directly. Especially with rough surfaces and grasses, this undesired ground return can be a significant source of false positives.

Fixed thresholding is very common in previous research on radar navigation. The advantage to this approach is that data can be processed instantaneously as it arrives from the antenna, rather than being formed into a 2D image. Thresholding represents an effort to connect intensity of backscatter to the risk associated with hitting an object. High intensity means more danger, and vice versa. Unfortunately, these properties are actually poorly related.

Many objects have strong returns in the 77 GHz range but do not post a significant obstacle to automotive vehicles. Brush, grass, small ruts, gradual inclines, and other features show strongly with high intensity backscatter returns but are easily traversable by automotive vehicles. Conversely, many potentially dangerous metal objects are only visible in backscatter returns from certain angles. Specific “stealth” examples are highway signs and hedgehog tank traps that return very low intensities from most angles but can be very dangerous.

While fixed threshold methods have led to reports of success in structured environments, extended testing in off-highway conditions revealed a large number of false positives caused by vegetation, rough roads, and gentle hills. Setting the threshold high enough to avoid most false positives also meant only the largest metal objects with internal angles (like automobiles) are reported, and even recognition of these objects is not perfect.

Energy filtering, on the other hand, is effected by convolving a rectangular kernel with the image. At every pixel, the intensities within the kernel were summed and if they pass a threshold, the pixel was classified as an obstacle. The energy filter works very well at detecting road edges like gutters and berms (common on dirt roads) and larger obstacles like cars and buildings. Unfortunately, it also has a lot of false positives.

Large areas of low intensity, which typically include grass and uphill road sections, tend to be falsely reported as obstacles using this filter. While a car or building wall will typically be splotchy—strong returns mixing with near zero returns from angled surfaces or shadows—even mown lawn grass may produce steady returns over its whole area. For this reason, measuring energy in a region was a poor discriminator of obstacles in the scope of this research.

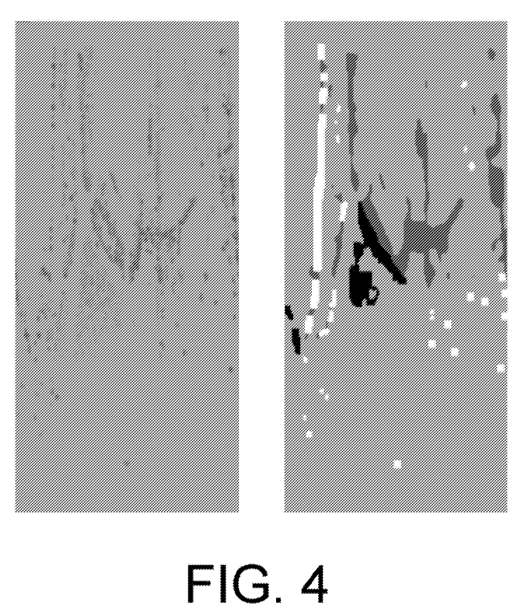

FIG. 4 shows the application of an energy filter to radar data, and highlights the disadvantages of this approach. The image on the left shows unprocessed radar data, where red corresponds to high backscatter returns. The right image is the same data processed with an energy filter. Green is safe to drive, red represents identified obstacles, white is missed obstacles, and black is false positives. Most of the black region (false positives) is mown grass, which is easily traversed by a HMMWV.

The failure of more straightforward methods suggests making use of more sophisticated models of a priori data. Since a sensor in accordance with at least one preferred embodiment of the present invention can support an already navigable vehicle, it might be possible to turn off the radar in situations where the previous methods are known to be untrustworthy. Then, obstacles will only be reported in areas of high confidence, reducing correct detections, but potentially reducing false positives to acceptable levels.

Data collection in the Nevada desert has indicated that native vegetation tends to occur in clusters, rather than small, isolated stands. For instance, it is likely that an area either has a lot of sagebrush growing close together, or only possesses low grass and roadway. Most desert terrain either contains a very large or very small amount of clutter, without much of a middle ground.

Observations indicated that energy and thresholding methods worked well in these areas of low clutter, so if they could be identified, the results from this filtering would be acceptable. An algorithm to take advantage of this characteristic should devalue confidences in regions containing large amounts of clutter.

The global clutter filter creates a histogram of all values in the radar image. It then selects the intensity at a percentile selected as a parameter and subtracts that intensity from all values in the image. This was optimized by experimentation at the 80^{th} percentile. If an image is 80% empty of backscatter, a common occurrence in low-clutter regions, this filter will have no effect on the raw data. In areas where more than 20% of the image contains significant backscatter, all returns are decreased. This effectively increases the burden of proof for the next stage of filtering.

Combining the global clutter filter with the energy or threshold filters is sufficient to identify many obstacles with few false positives. This method is robust to areas of high clutter and works well at identifying obstacles in otherwise clear areas. Because it only identifies obstacles in low-density environments, however, it misses true obstacles in clutter-filled regions.

Local clutter filtering is another way to reduce confidence in the presence of clutter, but considers a reduced scope. A window centered on a pixel produces a histogram of pixel intensities within that window. The intensity at a particular percentile is subtracted from the pixel at the window's center. Therefore, this is the same algorithm as the global clutter filter, but is applied only on the area immediately surrounding a pixel. This approach produces limited success.

Since the antenna is a physical device with a Gaussian distribution of beam intensity in the azimuth direction, the beam width is not discrete. In fact, the cited 1.2° beam width is the half-power width. This means that a strongly reflecting object, even if it is small enough to fit into one azimuth bin, will “bleed” into the surrounding azimuth bins. Similarly, since the range measurement is a binned result from a continuous FFT, a reflecting object will also bleed intensity into the surrounding range bins. Therefore, a single point object like a fencepost or barrel will actually show intensity in at least 9 bins, and the edges of all objects will be fuzzy.

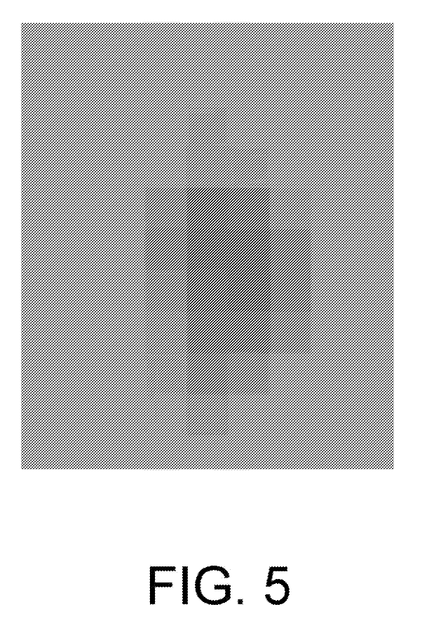

This phenomenon is clearly evident in FIG. 5, which shows the backscatter returns from a 30 gallon plastic trash can. The shape of the radar beam results in “bleeding” from the object into surrounding pixels causing a fuzzy appearance. A pixel with intensity of any real consequence is always surrounded by several pixels of non-zero intensity because of this bleeding effect. This overpowers the local clutter filter, because the bleeding is often the most significant source of non-zero intensity (clutter) in the histogram. The need to assemble and sort histograms at each pixel is also computationally intensive and difficult to manage in the real time required for high-speed driving.

Local clutter filtering is desirable, but the fuzzy edges of intensity blobs prevent its implementation as described. However, the robot only requires radar to detect obstacles in the road, not those off in the vegetation. Most forms of clutter, like vegetation, road inclines, and rough surfaces appear in bunches, while most manmade obstacles like fence posts, and telephone poles are isolated and surrounded by road or clear dirt. Even larger objects like Jersey barriers and buildings don't normally reflect back to the transmitter except at breaks like connections between concrete sections or windows. These obstacles all follow a pattern of non-backscattering bins surrounding a small set of high-intensity pixels.

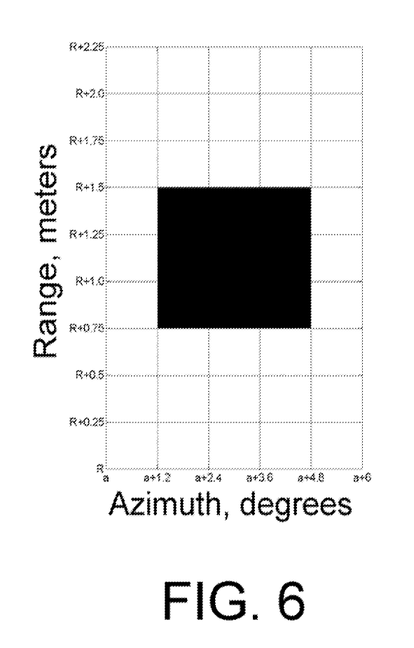

A context filter, as implemented and employed in accordance with at least one presently preferred embodiment of the present invention, eliminates objects surrounded by clutter and recognizes that most real obstacles are small and surrounded by intensities very close to zero. (In accordance with an illustrative embodiment of the present invention, the context filter can be employed as a “first filter” indicated at 214 in FIG. 2). As shown in FIG. 6, it may preferably use two kernels of different radii centered on the same pixel (FIG. 6). The inner kernel (here, nine pixels shaded in black) is “positive” space, while the outer annulus (the remainder, or here the thirty-six pixels not shaded in black) surrounding the inner kernel is “negative” space. Intensities within the positive space are summed like an energy filter, while intensities from the negative space are subtracted. The total is then normalized by the number of pixels in the inner kernel:

$$S = \frac{{\sum }_{i ∈ I} {S}_{i} - {\sum }_{o ∈ O} {S}_{o}}{\vert I \vert}$$

where S is the intensity, |I| is the number of inner pixels, and O is the set of outer pixels. If S is greater than zero, the center pixel is set to S, otherwise it is set to zero.

This filter distinguishes small objects surrounded by clear space and attenuates objects in close proximity with other objects. As a final step, a fixed threshold is preferably enforced to further bias the classifier away from false positives; with relation to the illustrative layout shown in FIG. 2 this could, for instance, be undertaken by second filter 218 and/or third filter 224 or, in an embodiment that does not involve branching as shown in FIG. 2, by essentially any filter that is downstream of first filter 214.

With the filter implemented in this way, there can still be false positives on very smooth driving surfaces. Some minor rocks or rough patches slip through because the surrounding asphalt returns virtually no backscatter to the antenna. Only considering center pixels with intensity greater than an initial threshold eliminates the smooth asphalt false positives. Because so much of an image is blank, this also eliminates the significant majority of the processing requirements by not processing pixels that clearly don't contain obstacles.

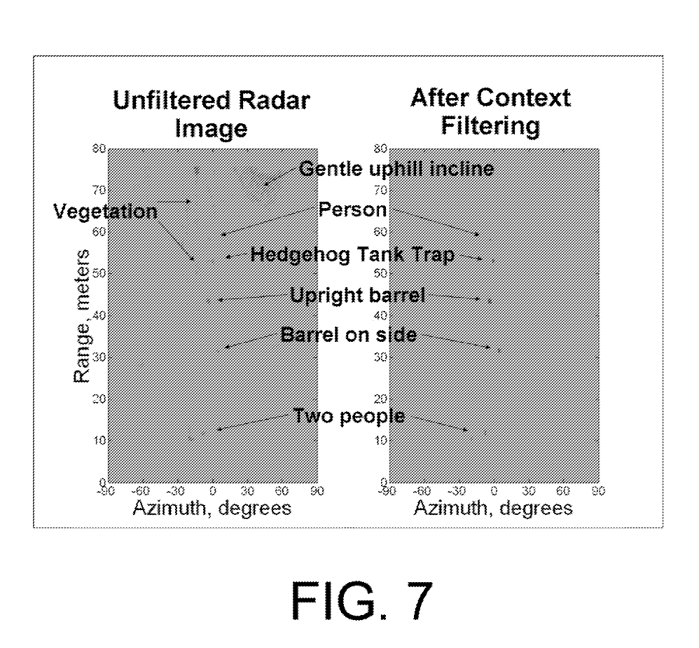

FIG. 7 graphically illustrates unprocessed and context filtered radar data from a desert scene in Nevada. This comparison demonstrates how obstacles of interest are preserved by this filtering while clutter is eliminated. As shown in FIG. 7, the context filter is extremely successful at detecting the obstacles in the context and scope of this research. It has very low rates of false positives because it automatically becomes less sensitive in high clutter areas. By its design, this filter uses the context of an obstacle, not just its shape or intensity; the former is not recognizable by the low resolution beam and the latter is poorly correlated with obstacle danger. An area with no radar backscatter return isn't always clear, because angled surfaces can be stealth objects or the vertically narrow beam may be aiming above obstacles. Receiving even significant backscatter may mean nothing because it could come from grass, a gentle incline, or rough road surface. A backscattering object surrounded immediately by zero-intensity bins, however, almost always means a significant obstacle in the road that threatens the autonomous vehicle.

Calibration parameters define the coordinate transformation between the radar and the vehicle. While the translation of the antenna origin can be physically measured from the vehicle origin, the algorithm is more sensitive to rotation, which occasionally needs recalibration. The Sandstorm vehicle (see, e.g., U.S. Provisional Application Ser. No. 60/812,593, supra) poses problems because its vehicle coordinate origin is relative to its electronics enclosure, which is independently suspended from the vehicle chassis. Since the radar antenna is mounted on the chassis, any change to the rest position of the E-box (electronic box, or box containing electronic components) requires a recalibration of the radar. This is accomplished manually through trial and error, usually by driving up to a set of identifiable obstacles and correcting for any that are incorrectly localized.

It is more difficult to tune the parameters dictating the context filter properties. Using a learning algorithm is difficult because hand-classifying the required number of objects is not feasible. Finding fully representative training data is also a daunting task. Therefore, these parameters were also developed through experience.

The two threshold parameters, exercised before and after the kernel convolution, were initiated at values as low as possible to maximize the number of correct detections. If too many false positives were observed, these values were increased.

Setting the radii of the two kernels is a more complicated problem. The inner radius dictates the maximum size of the obstacles that will be reported, while the outer radius determines how much clear space is required around an obstacle. They interact, however, such that the ratio of negative (outer) space to positive (inner) space also has a strong effect. If the ratio is 1:1 and the positive space is at a higher intensity than the outer space, an obstacle is reported. If the ratio is greater than 1:1, the obstacle must be more intense than the surrounding space to result in a reported obstacle.

Testing has shown that maximizing the outer radius relative to the inner radius maximizes the correct classification rates. Increasing the outer radius increases the amount of space required between obstacles, so there is a limit to how far this can be taken. Azimuth separations of 6° and range separations of 2.25 m were enforced, while objects of 3° width and 0.75 m depth were optimally preserved. The actual object may be a different size, however, because of bleeding or the fact that most objects don't reflect for their whole length, like a building only returning backscatter at irregularities like windows and doors.

The radar pipeline 210 preferably receives these parameters at runtime from the custom script language that controls it. In addition to calibration and filter settings, several other parameters are dictated by the hardware, like the angular width of azimuth bins. Radar devices may have slightly different scan rates and require individually tuned values. Since these values are passed at runtime, there is flexibility to change hardware during testing.

Turning now to the updating of images via blob-based hysteresis, navigation software typically polls perception routines like the radar module 230 for maps at a higher rate than the radar obstacle classifier refreshes, so persistence of obstacles is desirable. Also, an obstacle is not always visible in every sweep, instead appearing or disappearing as the vehicle approaches the obstacle. Because of this, a method of maintaining memory of obstacles is very desirable. This cannot be a rigid algorithm recording the location of all previous obstacles, however, because their position and size is refined as the vehicle gets closer.

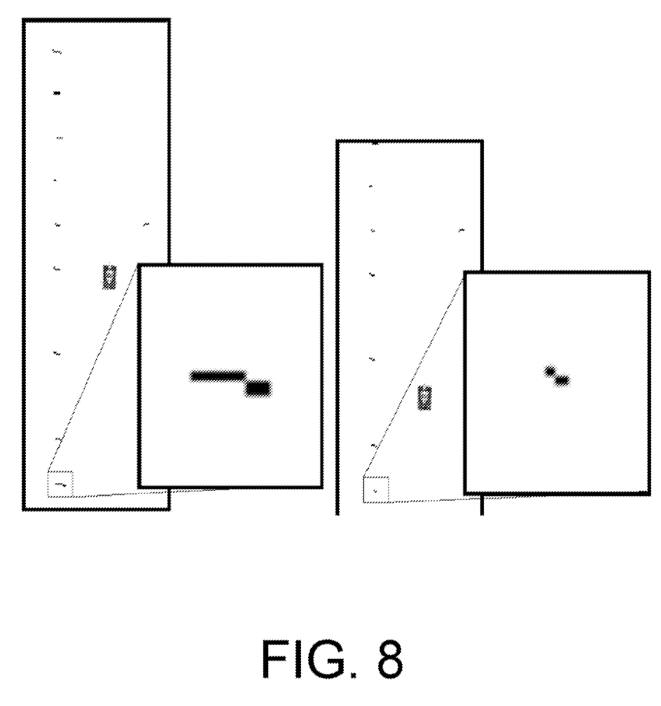

At long range, the angular resolution of the radar corresponds to several pixels in the rectangular space of the planner due to magnification. At a range of 50 meters, a single fencepost may appear as a several-pixel-wide object of 2 meters width or more. As the vehicle approaches the post, the reported obstacle width will narrow to the correct location. This can be appreciated from a working example graphically illustrated in FIG. 8. In the left image of FIG. 8 the robot is about 30 m from a magnified fence post. In the right image, the robot has approached to about 10 m and the object's location and shape is refined. Therefore, the memory should preferably have some flexibility to clear previously reported obstacles in the case of new, better information.

In one conceivable implementation, physics-based hysteresis takes advantage of the known physics of the context filter. Any obstacle that survives the context filter is surrounded by empty space by definition. Therefore, when an obstacle is reported, any pre-existing obstacle within a certain radius of it can be removed from memory. If a prior obstacle was reported somewhere and a new one appears very close to it, the algorithm assumes the old obstacle was misplaced or its size was overrepresented and uses the more recent information.

Because the area around the filter is expressed in polar coordinates, the clearing of this area must also be described by polar coordinates. With the 5 azimuth and 9 range pixels used in testing that means 45 “empty” pixels must be transformed from polar coordinates in the sensor's frame to Cartesian coordinates in the vehicle's frame for every obstacle-containing pixel. This is a non-trivial increase in the complexity of the transformation processing.

Unfortunately, physics-based hysteresis sometimes produces an aliasing effect. When the polar point is transformed into the vehicle reference frame, it is binned into the 0.25 m resolution of the map. At this stage, information is lost, and two objects may appear slightly closer or slightly further apart than they are in reality. Because of this, two obstacles that are just far enough apart to be identified can incorrectly clear each other in the map using this hysteresis. This was first observed in a scene setup with several small boxes spaced about 1.5 m apart, close to the minimum range separation required to consider isolated obstacles. Some boxes were correctly identified but were later removed, creating the appearance of a clear path where there was none.

A blob-based hysteresis method, as broadly contemplated herein in accordance with at least one presently preferred embodiment of the present invention, and that operates solely in the Cartesian space of the obstacle map in memory, solves the aliasing problem. Testing demonstrates that localizing errors from the obstacle classifier are not significant. Obstacles do not appear to shift as the vehicle gets closer; they only get smaller as they are better localized. Therefore, an obstacle being added to the map for a second time should be contiguous with at least some part of the previous record of that obstacle.

Preferably, a blob-based hysteresis module 234 will check the location of a newly reported obstacle and remove any previous obstacle blob at that position, before filling in the new size information. Preferably, the algorithm involved may initially recursively search the 24 neighboring pixels of a new obstacle pixel for non-zero values. If any are found, they are set to zero and the surrounding 8 neighbors are recursively searched until the entire contiguous blob is removed.

This method acts as a blob tracker and therefore is only capable of eliminating an old obstacle to replace it with a new one at the same location. It maintains memory of all obstacles while simultaneously refining the size and location of an object as the vehicle approaches and more information is available.

The disclosure will now turn to a brief discussion of challenges with Doppler shifting and how such challenges might be addressed.

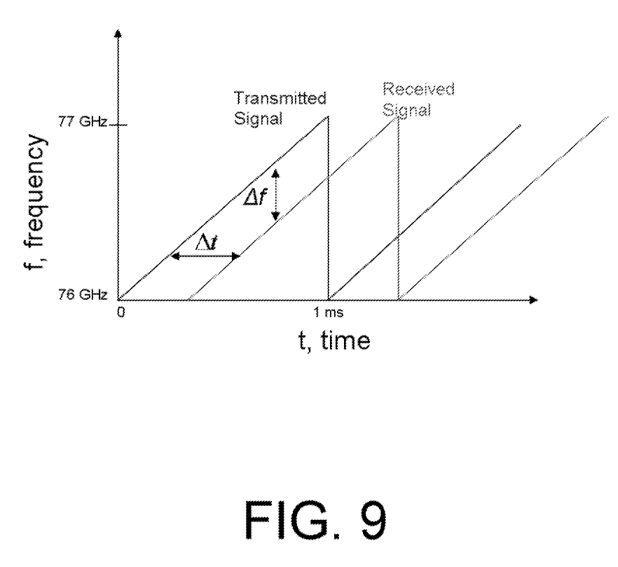

FMCW radars measure distance to a target using the backscatter returns' time-of-flight, Δt. This is accomplished by modulating the frequency of the transmitted signal in a sawtooth wave, as graphically illustrated in FIG. 9. In this way, the frequency of the transmission is indexed by time (Equation 1, below). When the signal returns to the radar, an FFT is performed to extract the frequency. With the frequency of the signal known, the time of transmission can be determined. Using the speed of light, the distance of a backscattering object can be calculated from this time-of-flight (Equation 2, below).

$$\begin{matrix}Δ t = \frac{Δ f * 1 ms}{1 GHz} & ( 1 ) \\ d = \frac{Δ t}{2} c & ( 2 )\end{matrix}$$

With a moving target or moving platform, however, backscattered signals are Doppler shifted. This means the frequency of a reflected signal is not the same as it was when transmitted, so the time indexing is incorrect. At the highest speeds driven by the robots during testing (about 20 m/s), this error in location (about 1.5 m) is enough to prevent obstacle avoidance and is certainly enough to keep a hysteresis algorithm from working properly. Fortunately, this Doppler shift behavior is a well understood problem (Equation 3) depending on λ, the wavelength, and ν, the closing velocity.

$$\begin{matrix}{f}_{d} = \frac{2 v}{λ} , λ \approx \frac{c}{76.5 GHz} & ( 3 ) \\ {d}_{corrected} = {d}_{measured} + 76.5 * 1 ms * v & ( 4 )\end{matrix}$$

If the velocity of the object toward the radar antenna is known, the Doppler shift can be corrected manually using Equation 4. In the testing described in this paper, all objects in the environment are static, so the only consideration is the speed of the robot. This speed is available to the radar module 230 from the vehicle pose information.

The Doppler shift is a significant problem that must be overcome to use FMCW radar in non-static environments. Two potential methods are increasing the rate of frequency modulation to limit the shift and using obstacle tracking to calculate the obstacles' velocity. Tracking would require an antenna with higher refresh rates and more processing power, however, so it is not apparent what the solution to this problem will be.

It will be appreciated from the foregoing that the present invention, in accordance with at least one presently preferred embodiment, indeed improves significantly upon conventional arrangements and affords obstacle detection and evasion, as well as reliable radar image updating, that contribute to much more efficient and effective operation of an autonomous vehicle. In brief recapitulation, the intensity of radar backscatter returns is generally a poor indicator of danger to a vehicle. Methods as broadly contemplated herein provide favorable counterexamples. An image of backscatter intensities is filtered with various image processing techniques then is thresholded as if it has become an image of risks or confidences. Derivation research investigates discriminant functions that allow arbitrary numbers of classes and can use separability and discriminability as confidences instead of a filtered version of intensity.

Preferably, the approaches discussed and contemplated herein in accordance with at least one embodiment of the present invention can be embodied as an add-on sensor to an already operable autonomous vehicle. As such, it might not be as viable if used as a primary or stand-alone sensor in an unstructured environment. Radar techniques to detect road edges [10] [15] or terrain quality would fill these gaps and may allow a radar-only, all-weather autonomous platform.

Without further analysis, the foregoing will so fully reveal the gist of the present invention and its embodiments that others can, by applying current knowledge, readily adapt it for various applications without omitting features that, from the standpoint of prior art, fairly constitute characteristics of the generic or specific aspects of the present invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

### REFERENCES

[1] Jones, W., “Keeping Cars from Crashing”, IEEE Spectrum, 2001, vol. 38 issue 9, pp. 40-45.
[2] Woll, J., “VORAD Collision Warning Radar”, IEEE Intl. Radar Conference, 1995, pp. 369-372.
[3] Gern, A., Franke, U., Levi, P., “Advanced Lane Recognition—Fusing Vision and Radar”, Proceedings of the IEEE Intelligent Vehicle Symposium, 2000, pp. 45-51.
[4] Wanielik, G., Appenrodt, N., Neef, H., Schneider, R., Wenger, J., “Polarimetric Millimeter Wave Imaging Radar and Traffic Scene Interpretation”, IEEE Colloquium on Automotive Radar and Navigation Techniques, 1998, pp. 4/1-4/7.
[5] Clark, S., Dissanayake, G., “Simultaneous localisation and map building using millimetre wave radar to extract natural features”, Proceedings of IEEE International Conference on Robotics and Automation, 1999, vol. 2, pp. 1316-1321.
[6] Currie, N., Brown, C., Principles and Applications of Millimeter-Wave Radar, Artech House, Boston, 1987.
[7] Foessel, A., Chheda, S., and Apostolopoulos, D. “Short-range millimeter-wave radar perception in a polar environment.” Proceedings of the International Conference on Field and Service Robotics, 1999, pp. 133-138.
[8] Kaliyaperumal, K., Lakshmanan, S., Kluge, K., “An algorithm for detecting roads and obstacles in radar images”, IEEE Transactions on Vehicle Technology, 2001, vol. 50, issue 1, pp. 170-182.
[9] Ferri, M., Galati, G., Naldi, M., Patrizi, E., “CFAR techniques for millimetre-wave miniradar”, CIE International Conference of Radar, 1996, pp. 262-265.
[10] Clark, S., Durrant-Whyte, H., “Autonomous land vehicle navigation using millimeter wave radar”, Proceedings of IEEE International Conference on Robotics and Automation, 1998, vol. 4, pp. 3697-3702.
[11] Ruff, T., “Application of Radar to Detect Pedestrian Workers Near Mining Equipment”, Applied Occupational and Environmental Hygiene, 2001, vol. 16, no. 8, pp. 798-808.
[12] Urmson, C., et al, “A Robust Approach to High-Speed Navigation for Unrehearsed Desert Terrain”, Journal of Field Robotics, accepted for publication.
[13] Koon, P., “Evaluation of Autonomous Ground Vehicle Skills”, master's thesis, tech. report CMU-RI-TR-06-13, Robotics Institute, Carnegie Mellon University, March, 2006.
[14] Urmson, C, “Navigation Regimes for Off-Road Autonomy”, doctoral dissertation, tech. report CMU-RI-TR-05-23, Robotics Institute, Carnegie Mellon University, May, 2005.

[15] Nikolova, M., Hero, A., “Segmentation of a Road from a Vehicle-Mounted Radar and Accuracy of the Estimation”, Proceedings of IEEE Intelligent Vehicles Symposium, 2000, pp. 284-289.

1. A method of providing obstacle detection in an autonomous vehicle, said method comprising the steps of:
obtaining a radar diagram;
discerning at least one prospective obstacle in the radar diagram;
ascertaining background scatter about the at least one prospective obstacle;
classifying the at least one prospective obstacle in relation to the ascertained background scatter; and
refining the radar diagram and reevaluating the at least one prospective obstacle;
said reevaluating comprising repeating said steps of ascertaining and classifying.

2. The method according to claim 1, wherein said classifying step comprises applying a context-based filter to data corresponding to the at least one prospective obstacle.

3. The method according to claim 2, wherein said step of applying a context-based filter comprises applying a kernel filter.

4. The method according to claim 3, wherein said step of applying a kernel filter comprises:
choosing at least one pixel from the radar diagram corresponding to a discerned prospective obstacle;
applying a first mathematical function to the at least one chosen pixel; and
applying a second mathematical function to at least one pixel disposed adjacent to the at least one chosen pixel; and
relating the first mathematical function and the second mathematical function towards classifying the at least one prospective obstacle.

5. The method according to claim 4, wherein said step of applying a second mathematical function comprises applying a second mathematical function to a plurality of pixels disposed about a periphery of the at least one chosen pixel.

6. The method according to claim 4, wherein:
said step of applying a first mathematical function comprises deriving a first aggregate intensity, corresponding to the at least one chosen pixel;
said step of applying a second mathematical function comprises deriving a second aggregate intensity, corresponding to the at least one pixel disposed adjacent to the at least one chosen pixel;
said relating step comprising subtracting the second aggregate intensity from the first aggregate intensity.

7. The method according to claim 6, wherein said relating step comprises normalizing, relative to a number of pixels in the at least one chosen pixel, the first aggregate intensity subtracted by the second aggregate intensity, to yield a normalized net intensity.

8. The method according to claim 7, wherein said classifying step further comprises classifying a discerned prospective obstacle as a binary obstacle if the normalized net intensity is greater than a predetermined threshold value.

9. The method according to claim 4, wherein the at least one chosen pixel corresponds to a maximum size for a prospective obstacle to be classified as a binary obstacle.

10. The method according to claim 9, wherein the at least one pixel disposed adjacent to the at least one chosen pixel corresponds to a desired extent of clear space adjacent a binary obstacle.

11. The method according to claim 1, wherein said discerning step comprises labeling at least one discerned obstacle with polar radar coordinates.

12. The method according to claim 11, wherein said refining comprises transforming at least a portion of the radar diagram from polar coordinates to rectangular coordinates.

13. The method according to claim 12, wherein said transforming step comprises accessing a vehicle pose history

14. The method according to claim 1, wherein said discerning step comprises time-stamping at least one discerned obstacle.

15. The method according to claim 1, wherein said reevaluating step further comprises applying hysteresis to data corresponding to the at least one prospective obstacle.

16. The method according to claim 15, wherein said step of applying hysteresis comprises evaluating, at different timepoints, bunched radar data corresponding to the at least one prospective obstacle.

17. The method according to claim 16, wherein said evaluating step comprises:
evaluating, at a first timepoint, a first group of bunched radar data corresponding to the at least one prospective obstacle; and
evaluating, at a second timepoint, a second group of bunched radar data corresponding to the at least one prospective obstacle;
the second group of bunched radar data being contiguous with respect to the first group of bunched radar data relative to a predetermined reference map.

18. The method according to claim 17, wherein said evaluating step further comprises:
replacing the first group of bunched radar data with the second group of bunched radar data; and
storing the first group of bunched radar data in a history.

19. A system for providing obstacle detection in an autonomous vehicle, said system comprising:
an arrangement for discerning at least one prospective obstacle in a radar diagram;
an arrangement for ascertaining background scatter about the at least one prospective obstacle;
an arrangement for classifying the at least one prospective obstacle in relation to the ascertained background scatter; and
an arrangement for refining the radar diagram and reevaluating the at least one prospective obstacle;
said refining and reevaluating arrangement acting to prompt a repeat of ascertaining background scatter about the at least one prospective obstacle and classifying the at least one prospective obstacle in relation to the ascertained background scatter.

20. The system according to claim 19, wherein said classifying arrangement is acts to apply a context-based filter to data corresponding to the at least one prospective obstacle.

21. The system according to claim 20, wherein said classifying arrangement acts to apply a kernel filter to data corresponding to the at least one prospective obstacle.

22. The system according to claim 21, wherein said classifying arrangement acts to:
choose at least one pixel from the radar diagram corresponding to a discerned prospective obstacle;
apply a first mathematical function to the at least one chosen pixel; and
apply a second mathematical function to at least one pixel disposed adjacent to the at least one chosen pixel; and
relate the first mathematical function and the second mathematical function towards classifying the at least one prospective obstacle.

23. The system according to claim 22, wherein said classifying arrangement acts to apply a second mathematical function to a plurality of pixels disposed about a periphery of the at least one chosen pixel.

24. The system according to claim 22, wherein:
the first mathematical function yields a first aggregate intensity, corresponding to the at least one chosen pixel;
the second mathematical function yields a second aggregate intensity, corresponding to the at least one pixel disposed adjacent to the at least one chosen pixel;
said classifying arrangement acts to subtract the second aggregate intensity from the first aggregate intensity.

25. The system according to claim 24, wherein said classifying arrangement further acts to normalize, relative to a number of pixels in the at least one chosen pixel, the first aggregate intensity subtracted by the second aggregate intensity, to yield a normalized net intensity.

26. The system according to claim 25, wherein said classifying arrangement further acts to classify a discerned prospective obstacle as a binary obstacle if the normalized net intensity is greater than a predetermined threshold value.

27. The system according to claim 22, wherein the at least one chosen pixel corresponds to a maximum size for a prospective obstacle to be classified as a binary obstacle.

28. The system according to claim 27, wherein the at least one pixel disposed adjacent to the at least one chosen pixel corresponds to a desired extent of clear space adjacent a binary obstacle.

29. The system according to claim 19, wherein said discerning arrangement acts to label at least one discerned obstacle with polar radar coordinates.

30. The system according to claim 29, wherein said refining and reevaluating arrangement acts to transform at least a portion of the radar diagram from polar coordinates to rectangular coordinates.

31. The system according to claim 30, wherein said transforming said refining and reevaluating arrangement further acts to access a vehicle pose history

32. The system according to claim 19, wherein said discerning arrangement acts to time-stamp at least one discerned obstacle.

33. The system according to claim 19, wherein said refining and reevaluating arrangement further acts to apply hysteresis to data corresponding to the at least one prospective obstacle.

34. The system according to claim 33, wherein said refining and reevaluating arrangement acts to evaluate, at different timepoints, bunched radar data corresponding to the at least one prospective obstacle.

35. The system according to claim 34, wherein said refining and reevaluating arrangement acts to:
evaluate, at a first timepoint, a first group of bunched radar data corresponding to the at least one prospective obstacle; and
evaluate, at a second timepoint, a second group of bunched radar data corresponding to the at least one prospective obstacle;
the second group of bunched radar data being contiguous with respect to the first group of bunched radar data relative to a predetermined reference map.

36. The system according to claim 35, wherein said refining and reevaluating arrangement further acts to:
replace the first group of bunched radar data with the second group of bunched radar data; and
store the first group of bunched radar data in a history.
